(19) United States
(12) Patent Application Publication
(10) Pub. No.: US 2026/0147551 A1
(43) Pub. Date: May 28, 2026

(54) INTERMEDIATE LANGUAGE GENERATION APPARATUS, INTERMEDIATE LANGUAGE GENERATION METHOD AND NON-TRANSITORY STORAGE MEDIUM

(71) Applicant: NEC Corporation, Tokyo (JP)

(72) Inventor: Kazuhisa ISHIZAKA, Tokyo (JP)

(73) Assignee: NEC Corporation, Tokyo (JP)

(21) Appl. No.: 19/177,915

(22) Filed: Apr. 14, 2025

(30) Foreign Application Priority Data
Apr. 24, 2024 (JP) 2024-070202

(51) Int. Cl. G06F 8/41

(52) U.S. Cl. CPC G06F 8/41

(57) ABSTRACT

An intermediate language generation apparatus generates second intermediate language by a second compiler in generating intermediate language for a program in which a repetitive process is written; and determines whether or not the repetitive process can be reduced based on the second intermediate language, and generates by a first compiler based on the second intermediate language, in a case where reduction is possible, the first intermediate language for the program in which the repetitive process has been reduced from the program.

This application is based upon and claims the benefit of priority from Japanese patent application No. 2024-070202, filed Apr. 24, 2024, the disclose of which is incorporated herein in its entirety by reference.

### TECHNICAL FIELD

The present disclosure relates to an intermediate language generation apparatus, an intermediate language generation method, and a non-transitory storage medium.

### BACKGROUND ART

There are library functions that receive user-defined functions to perform repetitive processes. An example of a user program including a user-defined function is indicated below.

### (User Program Including User-Defined Function) #User-Defined Function

def func(row):
   return row[“a”]+row [“b”]
#Calling library function
tbl[“c”]=tbl.apply (func)

The user-defined function func(row) is a function that receives, as arguments, row data in table-form data, matrix data, etc., and that returns the sum of the values of column a and column b in the received row data. In the user program, the user-defined function func(row) is provided as an argument in an apply function for a tbl (Table object), and the result thereof is set in column c in the table indicated by tbl. An example of the library function tbl.apply is indicated below.

```
(Library function)
class Table:
  def apply(self, func):
    for row in self.rows:
      func(row)
```

This library function apply (self, func) is a library function that receives itself (Table object) and the user-defined function func(row), and that calls and executes the user-defined function func(row) for each row in the table itself. FIG. 1 indicates an example of the execution results of the above-mentioned user program with respect to a table A1 to be processed. The user-defined function can be used to implement functions not provided by the library.

Consider the generation of intermediate language for the above-mentioned user program. In this case, the intermediate language is, for example, as indicated below.

#Zero-th row
%1 = get_row(%tbl, 0)
%2 = get_scalar(%1, “a”)
%3 = get_scalar(%2, “b”)
%4 = add_scalar(%2, %3)
%5 = set_row(%result, 0, %4)
#First row
%6 = get_row(%tbl, 1)
%7 = get_scalar(%6, “a”)
%8 = get_scalar(%7, “b”)
%9 = add_scalar(%8, %3)
%10 = set_row(%result, 1, %9)

(Remaining parts omitted. Similar intermediate language is generated for every row in the table.)

The command get_row(% tbl, 0) is for reading out the zero-th row in a designated table, the command get_scalar(%1, “a”) is for reading out column a from column %1, the command add_scalar(%2, %3) is for adding %2 and %3, and the command set_row(% result, 0, %4) is for setting % 4 as % result (column c) in the zero-th row. When generating intermediate language for a user program including repetitive processes such as processes for each row or each column in table form data or matrix data, the same number of commands require to be generated as the number of repetitions. This is a cause of increases in processing cost. Specifically, there is a possibility of speed reductions due to intermediate language command generation overhead or generated command execution overhead, increases in the amount of memory used due to large amounts of commands, etc.

One more example will be given as an example of generating intermediate language for a repetitive process. A feature by which a library function for generating intermediate language when executing a program calls a function provided by another library (also known as a parent library), and allows the function to be used from the user program as an alternative library, is called a fallback. Additionally, the called function is called a fallback function. From the user, it appears as if the library functions include the fallback function in the parent library. By making use of a fallback arrangement, functions that are not included among the library functions can be supplemented.

An example in which the above-mentioned library functions do not include the apply function and the apply function included in a parent library is used as a fallback function is indicated below.

### (Library Function Using Fallback)

class Table:

```
def apply(self, func):
  parent_table = to_parent(self)
  def wrapper(parent_row):
    row = from_parent(parent_row)
    ret = func(row)
    return to_parent(ret)
result = parent_table.apply(wrapper)
return from_parent(result)
```

The command to_parent( ) is for converting the data structure of the library function (local library) to the data structure of the parent library, and the command from_parent( ) is for converting the data structure of the parent library to the data structure of the local library. The library function making use of the fallback provides the parent library with a wrapper (wrapper function) in which are written a process for converting row data from the data structure of the parent library to the data structure of the local library and a process for providing the converted row data to the user-defined function func, executes the apply function on the parent library side, receives the result thereof, and converts the result from the data structure of the parent library to the data structure of the local library. When calling the fallback function, there are cases in which a user-defined function cannot be directly provided to the parent library, and the parent library is provided with a wrapper function (wrapper) which includes a feature for converting the data structure of the library function and the data of the parent library. Since the data structure is converted for each row in a table, the processing cost increases. Specifically, there is a high likelihood of occurrence of decreased processing speed and increased memory usage due to large amounts of data conversion at the time of fallback and large amounts of commands.

As related technology, Patent Document 1 (Japanese Unexamined Patent Application, First Publication No. 2009-26048) describes a compile processing method having a first compiler for reading a source program and generating intermediate language (also known as an intermediate representation (IR)), and a second compiler for reading the generated intermediate language and generating object code.

### SUMMARY

One objective is to provide a method for preventing the generation of a large amount of commands when generating intermediate language for a program including repetitive processes.

According to an example of an embodiment disclosed herein, an intermediate language generation apparatus is provided with at least one memory configured to store instructions; and at least one processor configured to execute the instructions to: generate second intermediate language from a program by a second compiler in generating intermediate language for the program, in which a repetitive process is written; and determine whether or not the repetitive process can be reduced based on the second intermediate language, and generate by a first compiler based on the second intermediate language, in a case where reduction is possible, the first intermediate language for the program in which the repetitive process has been reduced from the program.

According to an example of an embodiment disclosed herein, an intermediate language generation method includes steps of generating second intermediate language from a program by a second compiler in generating intermediate language for the program, in which a repetitive process is written; and determining whether or not the repetitive process can be reduced based on the second intermediate language, and generating by a first compiler based on the second intermediate language, in a case where reduction is possible, the first intermediate language for the program in which the repetitive process has been reduced from the program.

According to an example of an embodiment disclosed herein, a program makes a computer execute a process of generating second intermediate language from a program by a second compiler in generating intermediate language for the program, in which a repetitive process is written; and determining whether or not the repetitive process can be reduced based on the second intermediate language, and generating by a first compiler based on the second intermediate language, in a case where reduction is possible, the first intermediate language for the program in which the repetitive process has been reduced from the program.

### BRIEF DESCRIPTION OF THE DRAWINGS

FIG. 1 is a diagram illustrating an example of execution results of a user program.

FIG. 2 is a diagram illustrating an example of an intermediate language generation apparatus according to an example embodiment.

FIG. 3 is a diagram schematically illustrating an intermediate language generation process and execution process according to an example embodiment.

FIG. 4 is a diagram illustrating an example of a front end configuration according to an example embodiment.

FIG. 5 is a diagram schematically illustrating an intermediate language generation process according to an example embodiment.

FIG. 6 is a flow chart illustrating an example of an operation example 2 according to an example embodiment.

FIG. 7 is a diagram illustrating an example of an operation example 2 according to an example embodiment.

FIG. 8 is a diagram for explaining an operation example 3 according to an example embodiment.

FIG. 9 is a flow chart indicating an example of an intermediate language generation process according to an example embodiment.

FIG. 10 is a diagram illustrating another example of an intermediate language generation apparatus according to an example embodiment.

FIG. 11 is a flow chart indicating an example of operations in an intermediate language generation apparatus according to an example embodiment.

FIG. 12 is a diagram illustrating an example of the hardware configuration of an intermediate language generation apparatus according to an example embodiment.

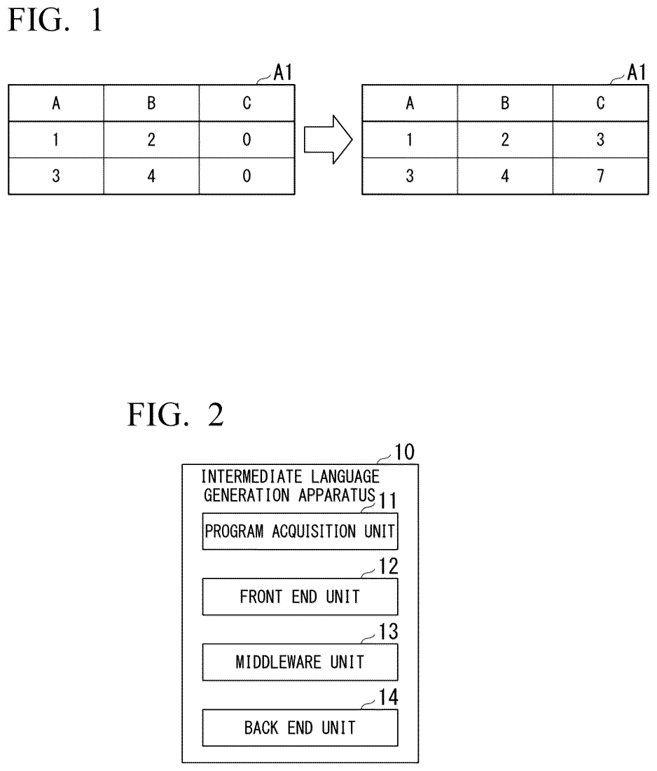

### EXAMPLE EMBODIMENTS

Hereinafter, intermediate language generation processes according to example embodiments disclosed herein will be explained with reference to the drawings. Regarding the features in portions unrelated to the present disclosure in the drawings used for the explanation below, there are cases in which descriptions of the features are omitted and the features are not illustrated in the drawings. Identical or corresponding features in all of the drawings are assigned identical reference symbols, and there are cases in which common explanations are omitted.

### EXAMPLE EMBODIMENT

### (System Configuration)

FIG. 2 is a diagram illustrating an example of an intermediate language generation apparatus 10 according to an example embodiment.

The intermediate language generation apparatus 10 is provided with a program acquisition unit 11, a front end unit 12, a middleware unit 13, and a back end unit 14.

The program acquisition unit 11 acquires a program (user program) to be executed. The front end unit 12 generates intermediate language for the user program acquired by the program acquisition unit 11. The front end unit 12 determines whether or not reduction is possible regarding repetitive processes included in the user program, and if reduction is possible, generates intermediate language in which the processes are changed so that the repetitive processes are reduced.

The middleware unit 13 optimizes the intermediate language of the entire user program generated by the front end unit 12.

The back end unit 14 executes the intermediate language optimized by the middleware unit 13.

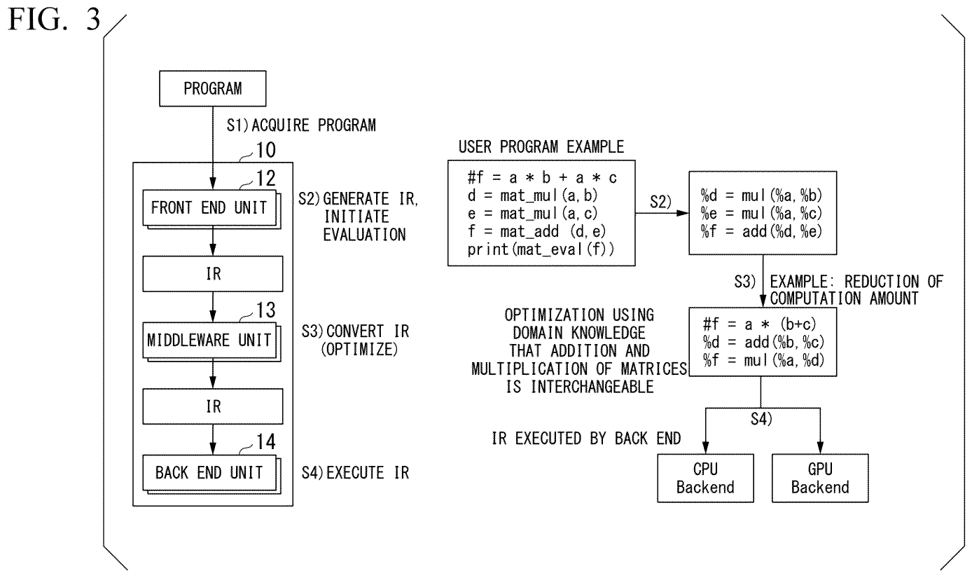

FIG. 3 schematically illustrates an intermediate language generation process and execution process performed by the intermediate language generation apparatus 10. (S1) The program acquisition unit 11 acquires a program (for example, User Program 0 below), and provides the program to the front end unit 12.

(User program 0)
d = mat_mul(a, b)
e = mat_mul(a, c)
f = mat_add(d, e)
print(mat_eval(f))

In this case, mat_mul, mat_add, and mat_eval are functions included in a library using intermediate language. The function mat_mul is a library function that generates intermediate language for multiplying the arguments. The expression mat_mul(a, b) generates intermediate language for executing the operation a×b (just the intermediate language is generated, and the operation a×b is not executed). The function mat_add is a library function that generates intermediate language for adding the arguments. The expression mat_add(d, e) generates intermediate language for executing the operation d+e (just the intermediate language is generated, and the operation d+e is not executed). The function mat_eval is for instructing the execution of the generated intermediate language. When mat_eval(f) is called, the intermediate language for performing the operation f is executed (delayed execution). At this time, the operation d+e is executed. Additionally, the intermediate language for calculating d and e required for the operation f is also executed, so that the operations a×b and a×c are executed.
(S2) The front end unit 12 generates intermediate language. The front end unit 12 outputs the generated intermediate language to the middleware unit 13.

### (Example of Generated Intermediate Language of User Program 0)

%d = mul(%a, %b)
%e = mul(%a, %c)
%f = add(%d, %e)

(S3) The middleware unit 13 optimizes the intermediate language. In the case of this example, the operation a×b+a×c can also be written a×(b+c), and since a×(b+c) involves fewer computations, the middleware unit 13 optimizes the intermediate language, for example, as indicated below. The middleware unit 13 outputs the optimized intermediate language to the back end unit 14.

### (Example of Optimized Intermediate Language)

%d = add(%b, %c)
%f = mul(%a, %d)

(S4) The back end unit 14 executes the intermediate language. The back end unit 14 executes mat_eval(f). At this time, the intermediate language generated up to the previous step is executed (delayed execution). Since the intermediate language is abstract, the user program can be executed on various platforms, such as a CPU or a GPU, without changing the user program.

Next, the configuration of a front end unit 12 that provides a feature for preventing the generation a large amount of commands when generating intermediate language for a program including repetitive processes will be explained.

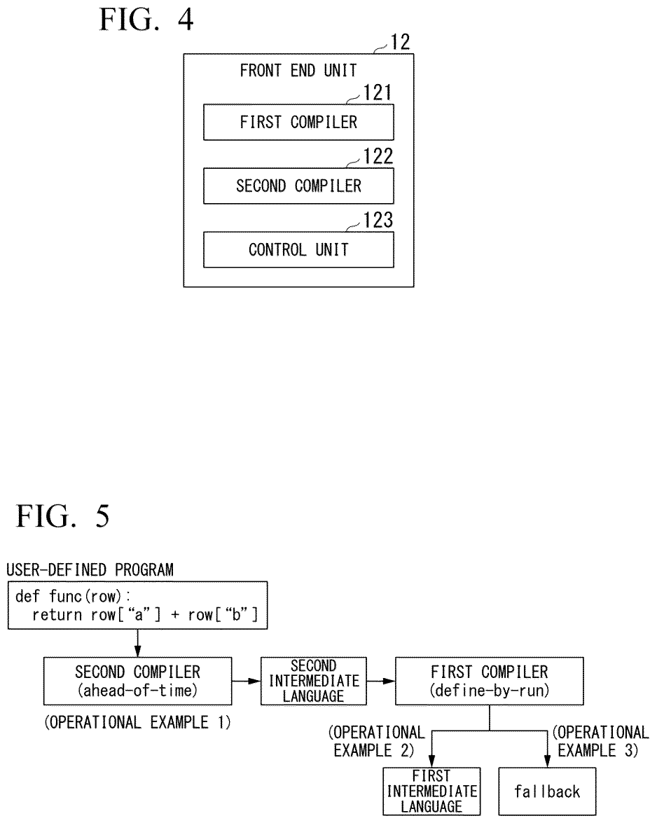

FIG. 4 is a diagram illustrating an example of the configuration of the front end unit 12.

The front end unit 12 is provided with a first compiler 121, a second complier 122, and a control unit 123.

The first compiler 121 generates intermediate language for a program by a define-by-run scheme. Generating intermediate language by a define-by-run scheme means that, when commands, functions, etc. written in a program are called, intermediate language indicating execution of those functions, etc. is generated. As mentioned above, the generated intermediate language is later executed by the back end unit 14 (delayed execution). The first compiler 121 generates the intermediate language based on the determination results by the control unit 123.

The second compiler 122 generates intermediate language for the program in an ahead-of-time scheme. A compiler in an ahead-of-time scheme is, for example, a compiler for the language C, etc. Whereas the first compiler 121 converts functions, etc. written in a user program to intermediate language when they are executed (for example, when there is code that is branched by an if statement, intermediate language is generated only for code passing the branch, and intermediate language is not generated for code that does not meet the conditions of the if statement and that does not pass), the second compiler 122 analyzes the entire source code and converts it to intermediate language (intermediate language for an entire block of an if statement is generated). For example, if a user program includes a repetitive process, the first compiler 121 loads processes repeatedly in an interpreter scheme and generates intermediate language equivalent to the number of repetitions. However, the second compiler 122 converts the code of the repetitive process directly into intermediate language. The second compiler 122 does not require domain-specific knowledge for a data processing library in table form, such as a matrix, chart, or table, and merely requires knowledge regarding the programming language and knowledge of type inference. Hereinafter, the intermediate language generated by the first compiler 121 will be referred to as first intermediate language, and the intermediate language generated by the second compiler will be referred to as second intermediate language.

The control unit 123 analyzes the second intermediate language generated by the second compiler 122, determines whether or not a repetitive process can be replaced with a batch process, and in the case in which this is possible, rewrites the process in the second intermediate language in such a way. For example, suppose that there is a process, to be performed on a table having column A, column B, and column C, in which a process of reading out the data in column A and column B, and of determining the sum of the two items of data, is repeated for every row in the table. If a function or method is provided in which such a process is performed for an entire table without considering the number of rows, the control unit 123 determines that the process of repeatedly accessing rows written in the original program (library function) can be replaced with a function (batch process) performed with respect to the entire table, and if such a function or method is not provided, the control unit 123 determines that replacement is not possible. The control unit 123, when it is determined that replacement with a batch process is possible, replaces the repetitive process in the second intermediate language with a batch process. The first compiler 121 generates first intermediate language from the second intermediate language after replacement. When the control unit 123 has determined that replacement with a batch process is not possible, the first compiler 121 generates intermediate language for a process performed on each row equivalent to the number of repetitions. Additionally, the control unit 123 determines whether or not a wrapper function is required in the case in which a fallback function is used in a library function, as in the example above. If a wrapper function is unnecessary, the second intermediate language is rewritten to a library function without a wrapper function when the fallback function is called, and the second intermediate language for the library function with the wrapper function omitted is transferred to the first compiler 121. The first compiler 121 generates the first intermediate language based on the second intermediate language.

FIG. 5 schematically illustrates an intermediate language generation process according to the present example embodiment. The front end unit 12 uses the second compiler 122 to generate second intermediate language for a user-defined function by an ahead-of-time scheme (Operational Example 1). The control unit 123 determines whether or not repetitive processes can be replaced with a batch process based on the second intermediate language, and if replacement is possible, performs the replacement. The first compiler 121 generates the first intermediate language based on the results of determination and replacement by the control unit 123 (Operational Example 2). Additionally, if the program is using a fallback function, the control unit 123 determines whether or not a wrapper function that is used when calling a fallback function can be removed, and if this is possible, the wrapper function is removed. The first compiler 121 generates first intermediate language including the fallback based on the results of the determination by the control unit 123 (Operational Example 3). Hereinafter, an explanation will be provided by giving examples regarding Operational Examples 1 to 3.

### Operational Example 1

The conversion to the second intermediate language by the second complier 122 will be explained.

### (User-Defined Function)

def func(row):

$$return row [ a ] = row [ b ]$$

The second compiler 122 generates the intermediate language below from this user-defined function.

### (Second Intermediate Language)

$row:row = getarg(0)
$1:scalar = getitem($row:row, “a”:str)
$2:scalar = getitem($row:row, “b”:str)
$3:scalar = add($1:scalar, $2:scalar)
return $3:scalar

Conversion to the second intermediate language involves recognizing the structure of a user-defined function and using it to analyze whether or not a repetitive process can be replaced and whether or not a wrapper function used when calling a fallback function can be omitted. For this reason, when generating the second intermediate language, there is no need for domain-specific knowledge for a data processing library in table form, and it is sufficient to have knowledge of a programming language and knowledge of type inference. For example, there is no need for a getitem command to have the meaning “extracting a column from row data”, and it may be converted to intermediate language (second intermediate language) having the meaning of calling a ‘getitem’ method for a variable, row, of a programming language (for example, python). Additionally, the second compiler 122 does not call a function and generates intermediate language by reading the source code for a function.

### Operational Example 2

Next, an operation for generating first intermediate language with reduced repetitive processes based on the second intermediate language generated in Operational Example 1 will be explained. However, before doing so, the fact that processes performed on rows in the user-defined function described above can be rewritten to a process for an entire table will be explained.

### (User Program)

#User-defined function
def func(row):
return row[“a”] + row[“b”]
#Calling of library function
tbl[“c”] = tbl.apply(func)

Specifically, suppose that there is a presumption that the user program described above can also be written as indicated below.

### (Other Way to Write User Program)

$$tbl [ c ] = tbl [ a ] + tbl [ b ]$$

In this case, tbl[“a”] is a library function for reading out data from the entire column A in a table. By writing the program in this manner instead of calling the library function “apply” to provide a user-defined function, the first compiler 121 can generate the first intermediate language below. With the first intermediate language below, there is no dependence on the number of rows. Therefore, commands will not be generated for the number of rows, and the overhead will not increase.

(Intermediate Language when the User Program is Written in Another Way)

%1 = project(%tbl, “a”)
%2 = project(%tbl, “b”)
%3 = add(%1, %2)
%4 = setitem(%tbl, “c”, %3)

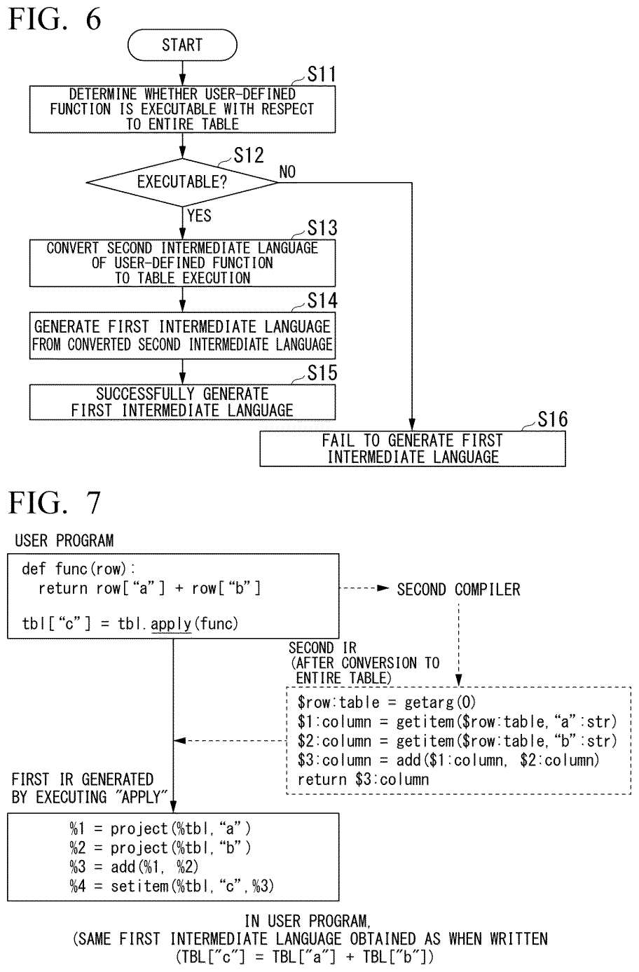

In the explanation below, it will be assumed that the control unit 123 has knowledge of a command for accessing an entire column. Next, Operational Example 2 will be explained by following the flow chart in FIG. 6.

The control unit 123 refers to the second intermediate language and determines whether a user-defined function can be executed with respect to an entire table (S11). The control unit 123 determines whether or not a command is executable with respect to a table when the second intermediate language below is executed one row at a time. Being executable with respect to a table means that the same result is obtained when the process in the second intermediate language is executed with respect to all rows and when the command is executed once with respect to the table.

### (Second Intermediate Language (Indicated Again))

$row:row = getarg(0)
$1:scalar = getitem($row:row, “a”:str)
$2:scalar = getitem($row:row, “b”:str)
$3:scalar = add($1:scalar, $2:scalar)
return $3:scalar

In the case of the above-mentioned process, the values of the respective rows are acquired by getitem ($row:row, “a”:str) and getitem ($row:row, “b”:str), and the sum of the acquired values is determined by add ($1:scalar, $2:scalar). Since the result does not change whether this process is repeated one row at a time or is executed with respect to the entire table, the control unit 123 determines that the user-defined function is executable with respect to the entire table. An example in which the user-defined function is not executable with respect to the entire table is indicated below.

(Example in which Command for Each Row Cannot be Replaced with Command for Table)

```
s = 0
def func(row):
  s += row[“a”]
  return row[“b”] + s
tbl[“c”] = tbl.apply(func)
```

In the case of this example, the data in column a of each row is successively added to an external variable s. Since the process performed for a certain row is affected by the value of the data in the previous row of column a, the processes in the respective rows are not independent. In such a case, the control unit 123 determines that the user-defined function func( ) is not executable with respect to the entire table. The control unit 123 may determine that a repetitive process cannot be replaced with a batch process if an external variable or an external function is used in a repetitive process.

The description will return to the example in which the user-defined function is executable with respect to the entire table. When the user-defined function is determined to be executable (S12: Yes), the control unit 123 converts the second intermediate language of the user-defined function to table execution (S13). The control unit 123 converts the second intermediate language indicated in “(Second intermediate language (indicated again))” above to be, for example, as indicated below.

(Second Intermediate Language after Type Conversion)

$row:table = getarg(0)
$1:column = getitem($row:table, “a”:str)
$2:column = getitem($row:table, “b”:str)
$3:column = add($1:column, $2:column)
return $3:column

In the “(Second intermediate language after type conversion)”, the data type of the arguments received by getarg(0), which means that the zero-th argument written in the first line of “(Second intermediate language (indicated again))” is to be acquired, is converted from the row type to the table type ($row:row→$row:table, where $row is the name of a variable and the data type of the variable $row is indicated after the colon; the same hereinafter). Additionally, in the second to fourth lines, the data types of the data acquired by “getitem” and the data added by “add” is converted from scalar type to column type (such as $1:scalar→$1:column). As a result thereof, the process of reading out and adding the data in each row is converted to second intermediate language for reading out the data in an entire column and adding each row for the entire column. The control unit 123 instructs the first compiler 121 to generate first intermediate language from the converted second intermediate language.

The first intermediate language is generated from the converted second intermediate language (S14). The first compiler 121 reads the “(Second intermediate language after type conversion)” one line at a time, and generates the intermediate language (first intermediate language) for the case in which the original programming language (for example, python) is executed in accordance with the meaning of each command in the second intermediate language. For example, the first compiler 121 reads the first two lines of the “(Second intermediate language after type conversion)” one line at a time, for the first line, calculating that a table (a table being a data type provided by the library) is to be substituted for the variable $row, and for the second line, calculating that tbl[“a”], which is a table data extraction function provided by the library, can be used, and generating the first intermediate language, %1=project (% tbl, “a”), by a define-by-run scheme. The first compiler 121 similarly performs conversions from the second intermediate language to the first intermediate language for subsequent processes, thereby generating first intermediate language as indicated below.

### (First Intermediate Language)

$row:table = getarg(0)
$1:column = getitem($row:table, “a”:str)
$2:column = getitem($row:table, “b”:str)
$3:column = add($1:column, $2:column)
return $3:column

When the first intermediate language is generated, the control unit 123 determines that the first intermediate language has been successfully generated (S15). Meanwhile, if it is determined that the user-defined function is not executable with respect to the entire table (S12: No), the control unit 123 determines that the generation of the first intermediate language has failed (S16). FIG. 7 indicates a diagram summarizing the Second Operational Example up to this point.

### Operational Example 3

Next, Operational Example 3 will be explained. Operational Example 3 is a process executed when the generation of the first intermediate language has failed. In Operational Example 3, if the library function is using a fallback function, it is determined whether or not a wrapper function used when calling the fallback function can be omitted, and if the omission is possible, first intermediate language with the omission is generated.

The control unit 123, when calling a fallback function, determines whether or not a wrapper function is required for the fallback, and if a wrapper function is unnecessary, transfers the user-defined function directly (without changing the data) to the parent library for the fallback, thereby reducing data conversion overhead. For example, the control unit 123 examines whether or not an external variable (a variable defined outside the function) is used for each command in the second intermediate language. If an external variable is not used, the control unit 123 determines that library-side data is not used in the user-defined function, and therefore, data conversion is unnecessary and a wrapper function is unnecessary. For example, suppose that the “Second intermediate language (indicated again)” mentioned above is intermediate language for a program using a fallback function. The control unit 123 determines that the processes in the second to fourth lines are processes that can be completed within the row provided as an argument and thus do not require data conversion. Additionally, for example, in the case of a user-defined function as indicated below, an external variable x is added to the value in each row of column B. In such a case, since the data structures of the external variable x on the library function side and the data in each row on the parent library side require to be matched, a wrapper function is required. For example, the control unit 123 may determine that the wrapper function cannot be omitted if an external variable or an external function is used in a repetitive process. In the case in which the wrapper function can be omitted, the control unit 123 instructs the first compiler 121 to convert the second intermediate language generated by the second compiler 122 to content with the wrapper function omitted, and to convert the converted second intermediate language to the first intermediate language. In the case in which the wrapper function cannot be omitted, the control unit 123 instructs the first compiler 121 to convert the second intermediate language generated by the second complier 122 to the first intermediate language. The first compiler 121 generates the first intermediate language from the second intermediate language.

### (User Program Using External Variable in User-Defined Function)

#x is an external variable

```
x = ...
def func(row):
  return row[“b”] + x
#apply is a fallback function
  tbl[“c”] = tbl.apply(func)
```

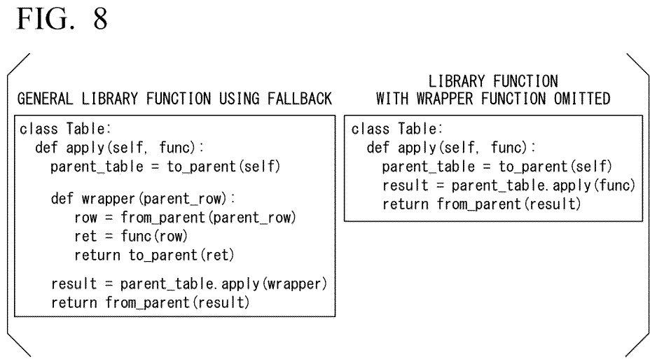

FIG. 8 indicates an example of a library function for the case in which a general library function and a wrapper function are omitted in the case in which a fallback function is called. In FIG. 8, the function 81 is a general library function, and the function 82 is the library function with the wrapper function omitted. In the case in which the control unit 123 has determined that the wrapper function can be omitted, the first compiler 121 generates first intermediate language corresponding to the function 82 in FIG. 8 from the second intermediate language, which is not illustrated. In the case in which the control unit 123 has determined that the wrapper function cannot be omitted, the first compiler 121 generates first intermediate language corresponding to the function 81 in FIG. 8 from the second intermediate language, which is not illustrated. The method for generating the first intermediate language from the second intermediate language, as explained in Operational Example 2, is to follow each line in the second intermediate language, and to generate first intermediate language for the case in which the original programming language is executed in accordance with the meaning of each command in the second intermediate language.

### Operations

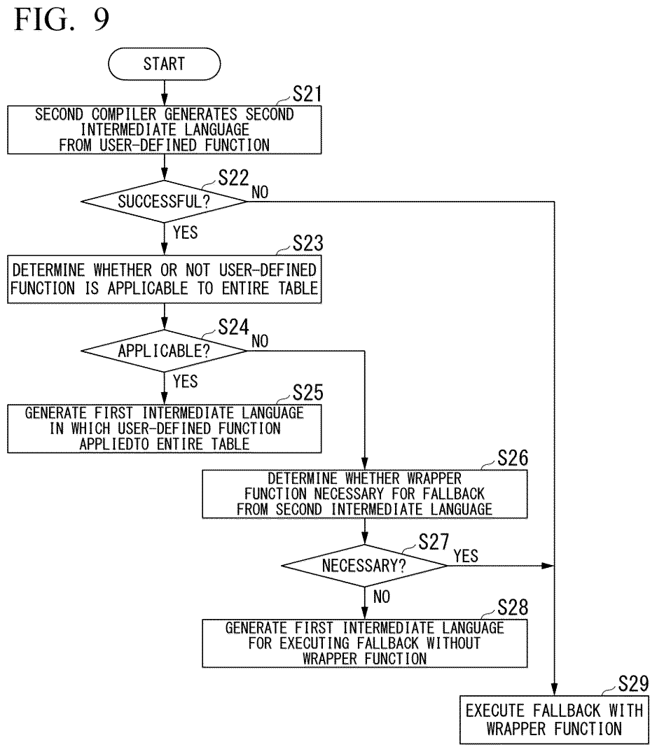

Next, by referring to FIG. 9, the intermediate language generation process that suppresses the generation of a large amount of commands when generating intermediate language for a repetitive process will be explained by using, as an example, the case in which the repetitive process is a user-defined function.

FIG. 9 is a flow chart indicating an example of an intermediate language generation process according to an example embodiment.

First, a second compiler 122 generates second intermediate language from a user-defined function (S21). In the case in which, for example, a command not supported by the second compiler is used in the user-defined function, there is a possibility that the second intermediate language cannot be generated. In such a case, the generation of the second intermediate language fails. If the generation of the second intermediate language has failed (S22: No), the process advances to step S29 described below. If the generation of the second intermediate language has succeeded (S22: Yes), the control unit 123 determines whether or not processes in the user-defined function are applicable to an entire table (S23). This is the same as S11 in FIG. 6. If the processes are applicable (S24: Yes), the first compiler 121 generates first intermediate language in which the processes in the user-defined function are applied to the entire table (S25). This is the same as S13 to S15 in FIG. 6. In this case, since repetitive processes are eliminated, the overhead can be largely reduced, and the highest speed processing becomes possible.

In the case in which the processes in the user-defined function are not applicable to the entire table (S24: No), the control unit 123 determines, from the second intermediate language, whether or not a fallback function is used in the user-defined function, and if a fallback function is used, determines whether or not a wrapper function is required (S26). For example, from the commands in the second intermediate language, it is recognized whether or not a parent library is to be called, and if a parent library is called, the control unit 123 determines that a fallback function is being used. Additionally, as explained in the example embodiment described above, if a user-defined function is provided to the fallback function and the user-defined function is executed on the parent library side, the control unit 123 determines whether or not a wrapper function is required or may be omitted, based on whether or not an external variable is used in the user-defined function. In the case in which a wrapper function is not necessary (S27: No), the control unit 123 changes the second intermediate language to content in which the wrapper function is omitted, and the first compiler 121 generates, from the changed second intermediate language, the first intermediate language for executing the fallback without the wrapper function (S28). In this case, the overhead of data conversion due to the wrapper function can be reduced.

In the case in which a wrapper function is required (S27: Yes), the first compiler 121 generates, from the second intermediate language generated by the second compiler 122, the first intermediate language for executing the fallback with the wrapper function (S29). Additionally, if the answer in S22 is No, the process in S29 is executed even in the case in which a fallback function is not used in the user-defined function. The first intermediate language generated in step S29 is the same as the intermediate language generated by a general process in a define-by-run scheme.

### Effects

As explained above, according to the present example embodiment, when generating intermediate language of a program including repetitive processes, the generation of large amounts of commands can be prevented, and the processing cost and the consumption of computer resources can be reduced. More specifically, the generation of large amounts of commands can be prevented by generating intermediate language by converting processing content so that processes of repeatedly executing a user-defined function on portions of the data, such as a row, as opposed to a table overall, become batch processes with respect to the data of the table overall, formed by collecting the portions. Additionally, regarding processes for fallback of processes of repeatedly executing a user-defined function on portions of the data as opposed to all of the data, the generation of large amounts of commands (data conversion commands) can be prevented by performing data conversion not in data units of the portions of data, but rather in data units of all data formed by collecting the portions of data.

In the example embodiment described above, an example of replacing processes performed on respective rows of table form data with processes performed on the entire table (all rows of the table) was described. However, similarly, in the case in which there are repetitive processes performed on respective columns of table form data in a program to be executed, the present example embodiment may be applied to generate first intermediate language by replacing processes performed on the respective columns with processes performed on the entire table (all columns of the table). Additionally, even in a case in which repetitive processes to be performed on respective columns or respective rows of table form data are not repeated for all columns or all rows, but rather are executed for some of the columns or some of the rows, if a function, etc. is provided so as to perform processes in a batch with respect to the range of columns or the range of rows to be processed, overhead increases due to intermediate language generation and the generation of large amounts of commands can be prevented by applying the present example embodiment and substituting the repetitive processes with said function.

### OTHER EXAMPLE EMBODIMENTS

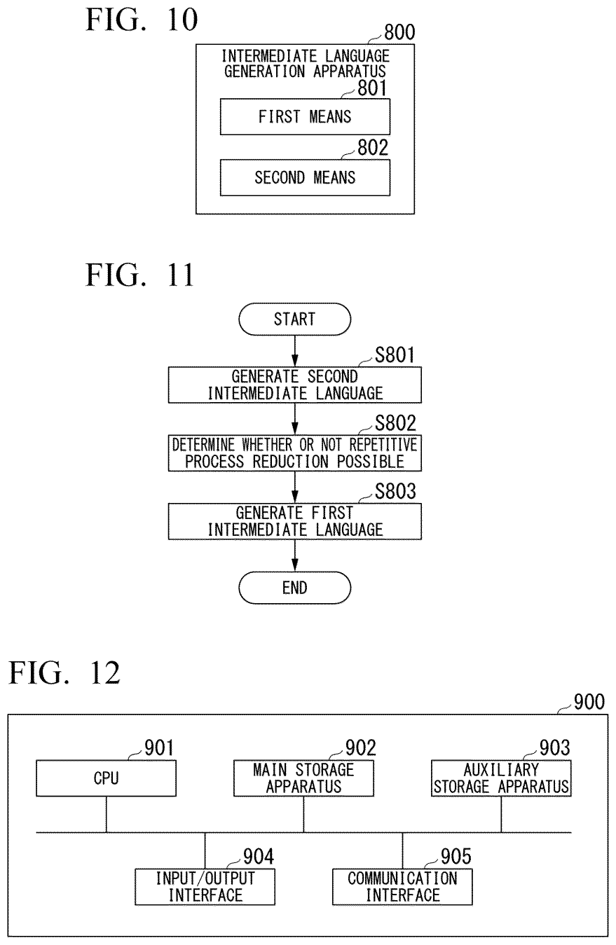

FIG. 10 is a diagram illustrating another example of an intermediate language generation apparatus according to an example embodiment.

The intermediate language generation apparatus 800 is provided with first means 801 and second means 802.

The second means 802, when generating intermediate language for a program in which a repetitive process is written, generates second intermediate language by means of a second compiler.

The first means 801 determines whether or not the repetitive process can be reduced based on the second intermediate language, and if reduction is possible, generates first intermediate language in which the repetitive process is reduced by means of a first compiler.

The front end unit 12 including the first compiler 121 and the control unit 123 is an example of the first means 801.

The front end unit 12 including the second compiler 122 is an example of the second means 802.

FIG. 11 is a flow chart indicating an example of the operations of the intermediate language generation apparatus according to an example embodiment.

The second means 802, when generating intermediate language for a program in which a repetitive process is written, generates second intermediate language by means of the second compiler (step S801).

The first means 801 determines whether or not the repetitive process can be reduced based on the second intermediate language (step S802), and if reduction is possible, generates first intermediate language in which the repetitive process is reduced by means of the first compiler (step S803).

FIG. 12 is a diagram illustrating an example of the hardware configuration of an intermediate language generation apparatus according to an example embodiment.

A computer 900 is provided with a CPU 901, a main storage apparatus 902, an auxiliary storage apparatus 903, an input/output interface 904, and a communication interface 905. The intermediate language generation apparatuses 10, 800 mentioned above are implemented in the computer 900. Furthermore, the respective functions mentioned above are stored in the auxiliary storage apparatus 903 in the form of a program. The CPU 901 reads the program from the auxiliary storage apparatus 903, loads the program in the main storage apparatus 902, and executes the processes described above in accordance with the program. Additionally, the CPU 901 secures storage areas in the main storage apparatus 902 in accordance with the program. Additionally, the CPU 901 secures, in the auxiliary storage apparatus 903, storage areas for storing data being processed in accordance with the program.

A program for realizing some or all of the functions of the intermediate language generation apparatuses 10, 800 may be recorded in a computer-readable recording medium, and the program recorded in this recording medium may be read into a computer system and executed to perform the processes according to the respective functional units. Additionally, in this case, a “computer system” refers to a system including an OS and hardware such as peripheral devices. Additionally, a “computer system” may include a homepage-providing environment (or display environment) in the case in which a web-based system is used. Additionally, a “computer-readable recording medium” refers to portable media such as CDs, DVDs, USBs, etc., and to storage apparatuses, such as hard disks, that are internal to a computer system. Additionally, in the case in which this program is distributed to the computer 900 by means of communication lines, the computer 900 to which the program has been distributed may load the program in the main storage apparatus 902 to execute the processes described above. Additionally, the program described above may be for realizing just some of the aforementioned functions, and furthermore, may realize the aforementioned functions in combination with a program already recorded in a computer system.

As described above, a library function that receives a user-defined function and performs repetitive processes is disclosed. According to the present disclosure, for example, the generation of a large amount of commands can be prevented when generating intermediate language for a program including repetitive processes.

While an example embodiment of the present disclosure has been explained in detail with reference to the drawings, the specific configurations are not limited to those mentioned above, and various design modifications, etc. are possible within a range not departing from the gist of this disclosure. Additionally, an example embodiment of the present disclosure can be variously modified within the range indicated in the claims, and embodiments obtained by appropriately combining the technical means disclosed respectively in different example embodiments are also included within the technical scope of the present disclosure. Additionally, configurations in which the elements mentioned in the example embodiments and modified examples described above and providing similar effects are replaced with each other are also included. Furthermore, the respective example embodiments can be combined, as appropriate, with other example embodiments.

Some or all of the example embodiments described above may be described as in the appendices below. However, the possible example embodiments are not limited to those indicated below.

### APPENDIX 1

An intermediate language generation apparatus comprising means for generating second intermediate language from a program by means of a second compiler in generating intermediate language for the program, in which a repetitive process is written; and means for generating first intermediate language based on the second intermediate language by determining whether or not the repetitive process can be reduced based on the second intermediate language, and if reduction is possible, generating, by means of a first compiler, the first intermediate language for the program in which the repetitive process has been reduced from the program.

### APPENDIX 2

The intermediate language generation apparatus according to appendix 1, wherein the first compiler generates the first intermediate language by a define-by-run scheme; and the second compiler generates the second intermediate language by an ahead-of-time scheme.

### APPENDIX 3

The intermediate language generation apparatus according to appendix 1 or appendix 2, wherein, in a case where the program, during the repetitive process, executes processes, relating to table form data, on a row or a column of the table form data, the means for generating the first intermediate language determines whether or not the processes on the row or column can be replaced with a batch process performed with respect to the entire table form data, and if replacement is possible, generates, by means of the first compiler, first intermediate language for the program in which the repetitive process in the program is replaced with the batch process performed with respect to the entire table form data.

### APPENDIX 4

The intermediate language generation apparatus according to any one of appendix 1 to appendix 3, wherein, in a case where the program calls an external library requiring data conversion during the repetitive process, the means for generating the first intermediate language determines whether or not the process of data conversion required for calling the external library can be reduced, and if reduction is possible, generates, by means of the first compiler, first intermediate language for the program in which the data conversion process is reduced.

### APPENDIX 5

An intermediate language generation method comprising steps of generating second intermediate language from a program by means of a second compiler in generating intermediate language for the program, in which a repetitive process is written; and generating first intermediate language based on the second intermediate language by determining whether or not the repetitive process can be reduced based on the second intermediate language, and if reduction is possible, generating, by means of a first compiler, the first intermediate language for the program in which the repetitive process has been reduced from the program.

### APPENDIX 6

A program for causing a computer to execute a process of generating second intermediate language from a program by means of a second compiler in generating intermediate language for the program, in which a repetitive process is written; and generating first intermediate language based on the second intermediate language by determining whether or not the repetitive process can be reduced based on the second intermediate language, and if reduction is possible, generating, by means of a first compiler, the first intermediate language for the program in which the repetitive process has been reduced from the program.

While preferred example embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. An intermediate language generation apparatus comprising:
at least one memory configured to store instructions; and
at least one processor configured to execute the instructions to:
generate second intermediate language from a program by a second compiler in generating intermediate language for the program, in which a repetitive process is written; and
determine whether or not the repetitive process can be reduced based on the second intermediate language, and generate by a first compiler based on the second intermediate language, in a case where reduction is possible, the first intermediate language for the program in which the repetitive process has been reduced from the program.

2. The intermediate language generation apparatus according to claim 1, wherein:
the first compiler is configured to generate the first intermediate language by a define-by-run scheme; and
the second compiler is configured to generate the second intermediate language by an ahead-of-time scheme.

3. The intermediate language generation apparatus according to claim 1,
wherein the at least one processor is configured to execute the instructions to:
in a case where the program, during the repetitive process, executes processes, relating to table form data, on a row or a column of the table form data, determine whether or not the processes on the row or column can be replaced with a batch process performed with respect to the entire table form data; and
generate by the first compiler, in a case where replacement is possible, first intermediate language for the program in which the repetitive process in the program is replaced with the batch process performed with respect to the entire table form data.

4. The intermediate language generation apparatus according to claim 1,
wherein the at least one processor is configured to execute the instructions to:
in a case where the program calls an external library requiring data conversion during the repetitive process, determine whether or not the process of data conversion required for calling the external library can be reduced; and
generate by the first compiler, in a case where reduction is possible, first intermediate language for the program in which the data conversion process is reduced.

5. An intermediate language generation method comprising:
generating second intermediate language from a program by a second compiler in generating intermediate language for the program, in which a repetitive process is written; and
determining whether or not the repetitive process can be reduced based on the second intermediate language, and generating by a first compiler based on the second intermediate language, in a case where reduction is possible, the first intermediate language for the program in which the repetitive process has been reduced from the program.

6. A non-transitory storage medium that stores a program for causing a computer to execute processes, the processes comprising:
generating second intermediate language from a program by a second compiler in generating intermediate language for the program, in which a repetitive process is written; and
determining whether or not the repetitive process can be reduced based on the second intermediate language, and generating by a first compiler based on the second intermediate language, in a case where reduction is possible, the first intermediate language for the program in which the repetitive process has been reduced from the program.
